(19) United States
(12) Patent Application Publication
(10) Pub. No.: US 2021/0019845 A1
(43) Pub. Date: Jan. 21, 2021

(54) Selecting a Real Estate Agent

(71) Applicants: Paula Grossman, Lillington, NC (US); Leigh Mullins, Cary, NC (US)

(72) Inventors: Paula Grossman, Lillington, NC (US); Leigh Mullins, Cary, NC (US)

(21) Appl. No.: 16/927,848

(22) Filed: Jul. 13, 2020

Related U.S. Application Data
(60) Provisional application No. 62/874,657, filed on Jul. 16, 2019.

(51) Int. Cl. G06Q 50/16; G06Q 30/06; G06Q 10/02

(52) U.S. Cl. CPC G06Q 50/16; G06Q 10/02; G06Q 30/0639; G06Q 30/0643

(57) ABSTRACT

A mechanism for a user to select a real estate property and have a real estate agent assigned based on a route score. The route score is the result of the computation that takes place in the software application, that executes on the application server. The computation accounts for distance between the real estate agent and the property, number of traffic lights, number of lanes on the roads, etc. Furthermore, a graphical user interface interacts with the software application which runs the application server for the purpose of communicating the results. The results are produced in the form of a computational route score. The route score is then used by the user to select the real estate agent who would take the shortest amount of time to reach the property.

### CROSS-REFERENCE TO RELATED APPLICATIONS

This application claims the benefit of U.S. Provisional Application No. 62/874,657, filed on Jul. 16, 2019, which is hereby incorporated in its entirety.

### FIELD OF THE INVENTION

The present invention is related to embodiments for computation of respective route scores to select a single real estate agent to meet with the user of a mobile device.

### BACKGROUND OF THE INVENTION

Potential real estate buyers generally utilize a desktop based real estate search service to identify properties of interest. Real estate sellers also utilize a desktop based real estate service to identify potential agents. These processes require potential buyers to do extensive research at home and document any properties of interest prior to visiting any potential locations. If the interested buyer identifies a potential property, the buyer must then contact the documented listing agency to schedule a visit to the property of interest. If the buyer requests an immediate showing, the buyer must rely on an agent's assessment of when the agent can meet with the buyer. This process is both time consuming and favors the real estate agencies.

### SUMMARY OF THE INVENTION

In an embodiment, a software application comprises a means to execute instructions sent from the graphical user interface (GUI) on a user device to an application server for the purpose of assisting users with identifying and locating real estate property and an agent that can represent said real estate property for purchase or for sale. The application server will execute computations that will allow for the calculation of the route between a real estate property and a real estate agent wherein the application will send the results of the computation to said user's device whereupon it will display said results on the GUI. The Graphical User Interface (GUI) will reside and be accessed from the user device. The GUI will communicate the request for a real estate agent to the application server wherein the software application that performs the computation of the routes between the real estate property and the selected real estate agent will reside on the application server. The GUI on the user device will communicate with said application server for the purpose of identifying, locating, and selecting a real estate property that the user would like to purchase. The GUI on the user device will communicate with said application server for the purpose of identifying a real estate agent to represent a property seller. Said application server will respond to the request for a real estate agent with a plurality of real estate agents that can represent the selected property. Said software application on the application server will communicate the results of that computation to the user's device. Then the selection of the plurality of real estate agents that are provided by the application server will include a route score upon which said user can base their selection of a real estate agent. The application server will then send a notification to the selected real estate agents, whereupon the agents who receive the notification will have the option to accept or reject an appointment for viewing the property, or representing the seller, with said user from real estate agent's GUI on said real estate agent's user device.

In another embodiment, the GUI that resides on said user device provides the mean for users to create individual profiles to be used for accessing or logging into said software application for the purpose of locating real estate agents who can show said user a selected property or represent a property that the users would like to [[sale]] sell. This gives the user the ability to input various criterion or filters into said GUI of the user device, wherein the criteria or filters are based on general location of desired property, number of bedrooms, number of bathrooms, days on the market, year built, and purchase price range. The user of the mobile device would have the ability to input various detail regarding a property for the purpose of locating a real estate agent to represent the sale of said property. The user device will receive notifications of real estate properties that match said provided criteria or filters as provided by said user.

In yet another embodiment, the user will select the property of interest on the GUI of their user device thereby sending a request to the application server to perform computation to determine the location of interest such that the location of interest is the location of the real estate agent's mobile device in reference to the location of the real estate property or another specified location. The user's device will receive notifications from the application server for real estate agents that are available to show said user the real estate properties that match the criteria and/or filters that were applied by the user.

In still another embodiment, the GUI further comprises receiving a mode selection of a plurality of modes from the user of the user device: (1) wherein the plurality of modes comprises a first mode for receiving only a single real estate agent; (2) wherein and the plurality of modes comprises a second mode for notifying all available agents within a proximity defined by the user; and (3) wherein the selecting the single selected real estate agent is responsive to receiving a mode selection of the first mode. Additionally, the software application comprises: (1) receiving a plurality of registrations from candidate real estate agents at different real estate companies; (2) determining available real estate agents by verifying that each of the candidate real estate agents is a licensed real estate agent; and (3) registering verified candidate real estate agents as registered real estate agents.

In a further embodiment, the software application comprises: (1) generating a verified identity associated with the mobile device by verifying an identity of a user of the mobile device; (2) associating the identity with an identifier of the mobile device (e.g., an international mobile equipment identity, IMEI); and (3) sending the selection of the single selected real estate agent only to the verified identity associated with the mobile device.

In another embodiment, the application server which also computes route scores, comprises: (1) communication equipment configured to receive, from a user device, an indication of a real estate property; (2) receiving, from the user device, a request for a real estate agent to show a user of the mobile device the real estate property; and (3) send, to the mobile device, a selection of a single selected real estate agent. The application server also includes processing equipment configured to: (1) determine a current location of a location of interest, wherein the location of interest comprises a location of the mobile device or a location of the real estate property; (2) determine respective current agent locations of a plurality of available real estate agents; (3) generate respective vehicle routes between the location of interest and each of the respective current agent locations; (4) compute respective route scores based on the respective vehicle routes; and (5) select, based on the respective route scores, the single selected real estate agent of the plurality of available real estate agents.

In a further embodiment, an application server, wherein said application server comprises: a non-transitory computer-readable storage medium containing a computer program comprising executable instructions that, when executed by a processing circuit of a mobile device, causes a mobile device to perform any of the methods of the embodiments. Additionally, the application server: (1) receives an indication of a message for the single selected real estate agent, the message related to meeting the user of the mobile device; (2) generates, responsive to the indication of the message, a generated message for the single selected real estate agent; and (3) forwards the generated message to the single selected real estate agent.

In still another embodiment, the application server comprises a software application used to identify respective vehicle routes which will be used for the purpose of computing respective route scores for each of the presented real agents. The computing of the respective route scores includes an accounting for physical objects, such as traffic lights, detour, accidents, traffic volume, and/or anything that may cause a time delay for the agent to reach the property, in proximity to respective vehicle routes. The computing of the route score also includes an accounting of one or more features of the given segment of road including a quantity of lanes of segments of the vehicle route or locations to change the direction of a vehicle.

In one embodiment, the notification from the application server regarding the list of the plurality of real estate agents are ranked according to route score. The application server comprises: (1) receiving a status indication from registered real estate agents; (2) and classifying registered real estate agents as available real estate agents for determining the respective current agent locations responsive to the status indication. Then the user selects a single agent from the plurality available agents based on the best route score, thus sending the selection notification to the mobile device of the selected real estate agent. At this point a response to selecting an agent, based on the computed respective route scores, sends a meeting request to the single selected real estate agent to meet the user at the location of the property upon receiving an acceptance from the selected real estate agent. Next, the sending of the selection of the single selected real estate agent is responsive to receiving the acceptance or rejection. Finally, if the user device receives an acceptance the real estate and the user can agree on a time to meet.

However, if the user device receives a rejection from the single selected real estate agent, the application server will send an updated selection of another real estate agent of the plurality of available real estate agents based on the computed respective route scores.

In a further embodiment, the application server comprises: a non-transitory computer-readable storage medium containing a computer program comprising executable instructions that, when executed by a processing circuit of an application server, causes the application server to perform any of the methods of the embodiments

In one embodiment, a mobile device comprises communication equipment configured to: (1) receive an indication of a real estate property; (2) transmit an agent request requesting a real estate agent to show a user of the mobile device the real estate property; and (3) receive a selection of a single selected real estate agent of a plurality of available real estate agents, wherein the selection is based on a computation of a route score for a vehicle route from the selected real estate agent to a location of the real estate property or the user of the mobile device; and processing equipment configured to determine when to transmit the agent request.

### BRIEF DESCRIPTION OF THE DRAWINGS

FIG. 1 shows a system diagram comprising an application server and a user device in at least one embodiment herein.

FIG. 2 shows how the calculated route score will assist with differentiating the location of each of the available real estate agents in relationship to the selected property.

FIG. 3 shows a block diagram of an application server in at least one embodiment herein.

FIG. 4 shows a method for selecting a real estate agent in at least one embodiment herein.

FIG. 5 shows a method for sending a meeting request to a real estate agent in at least one embodiment herein.

FIG. 6 shows a block diagram of a device in at least one embodiment herein.

FIG. 7 shows a method for receiving a selection of a real estate agent in at least one embodiment herein.

FIG. 8 shows a graphical user interface of a device for registering with an application server in at least one embodiment herein.

FIG. 9 shows a graphical user interface of a device for upgrading to an agent account in at least one embodiment herein.

FIG. 10 shows a graphical user interface of a device for indicating that a user is currently available in at least one embodiment herein.

FIG. 11 shows a process for selecting an agent in at least one embodiment herein.

FIGS. 12-14 show a user device with a graphical user interface for presenting various filter settings to a user in at least one embodiment herein.

FIG. 15 shows a user device with a graphical user interface of matching real estate properties for selection by the user in at least one embodiment herein.

FIG. 16 shows a user device with a graphical user interface of property details of a selected matching real estate property in at least one embodiment herein.

FIG. 17 shows an agent device with a graphical user interface showing information in response to an agent request in at least one embodiment herein.

FIG. 18 shows a graphical user interface for alerting or notifying a buyer of a selected agent in at least one embodiment herein.

### DETAILED DESCRIPTION

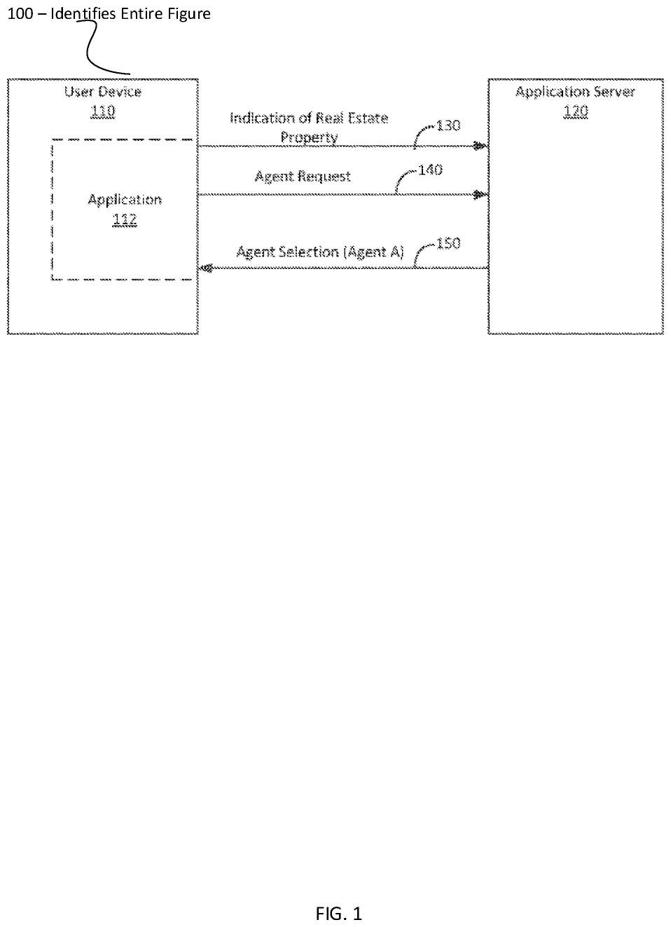

FIG. 1 shows a system 100 diagram comprising a user device 110 (e.g., a mobile device of a prospective buyer) and an application server 120.

As shown in FIG. 1, the user device 110 sends an indication 130 of a real estate property (e.g., a location of the property or filter information for filtering properties). Before, after, or contemporaneously with the indication 130, the user device 110 sends an agent request 140 requesting a real estate agent to show a user of the mobile device the real estate property or represent the user of the mobile device who may be selling the real estate property.

Responsive to the indication 130 and the agent request 140, the application server sends back an agent selection 150 of one or more selected real estate agents. Agents 270A, 270B and 270N are shown as an example of available real estate agents. Real estate agents may be available at any given time. The selection is based on a computation of a route score for a vehicle route from the selected real estate agent to a location 260 of the real estate property or the user of the mobile device. In this way, embodiments herein advantageously are not dependent on every available real estate agent to respond with an estimated time of arrival, which would burden the real estate community. Further, the computation of a route score can provide a more realistic time of arrival, in consideration of specific routing criteria, than an estimate by a real estate agent who may opportunistically underestimate how long it would take to reach the buyer or the buyer's property of interest.

For example, there may be one or more possible routes between a given agent and a given location 260 (e.g., there are 2 routes between Agent 270A and location 260) and those routes may overlap (e.g., routes for Agent 270A and 270B). A best route score may be selected for a given agent and the scores prioritized (e.g., shown in FIG. 1 by ranking route scores from 1 to 3). A single selected real estate agent (e.g., agent 270A) may be returned to the mobile device. Alternatively, multiple available real estate agents may be returned to the mobile device (e.g., a subset of available real estate agents fulfilling certain route score criteria or within certain proximity).

System 100 is described with respect to a user device 110 and application server 120. In one or more embodiments, the user device 110 is a mobile device (e.g., a laptop, tablet, phone, netbook, etc.). In one or more embodiments, the user device 110 communicates with an application server 120 that is a remote server from the user device 110 (e.g., a server accessible via wired or wireless communication), and system 100 refers to signaling via a communication network (not shown). Additionally, or alternatively, application server 120 comprises multiple servers' databases and/or other devices that collectively represent or function as an application server for communicating with a client or application on a user device (e.g., in a distributed computing network). Alternatively, the functionality of application 120 and/or user device 110 described herein may be implemented on one or more applications/clients 112 of the user device 110 (e.g., based on preinstalled or downloaded instructions stored on the mobile device) and system 100 refers to signaling internal to the mobile device or as communicated to or from an application on the mobile device.

For ease of explanation, embodiments herein will be described with respect to a user device 110 and application server 120, but these embodiments may instead be performed by application 112 on the user device 110. Further, system 100 shows use of a user device 110 and application 120 used together, but these devices may also be used separately (e.g., in other systems).

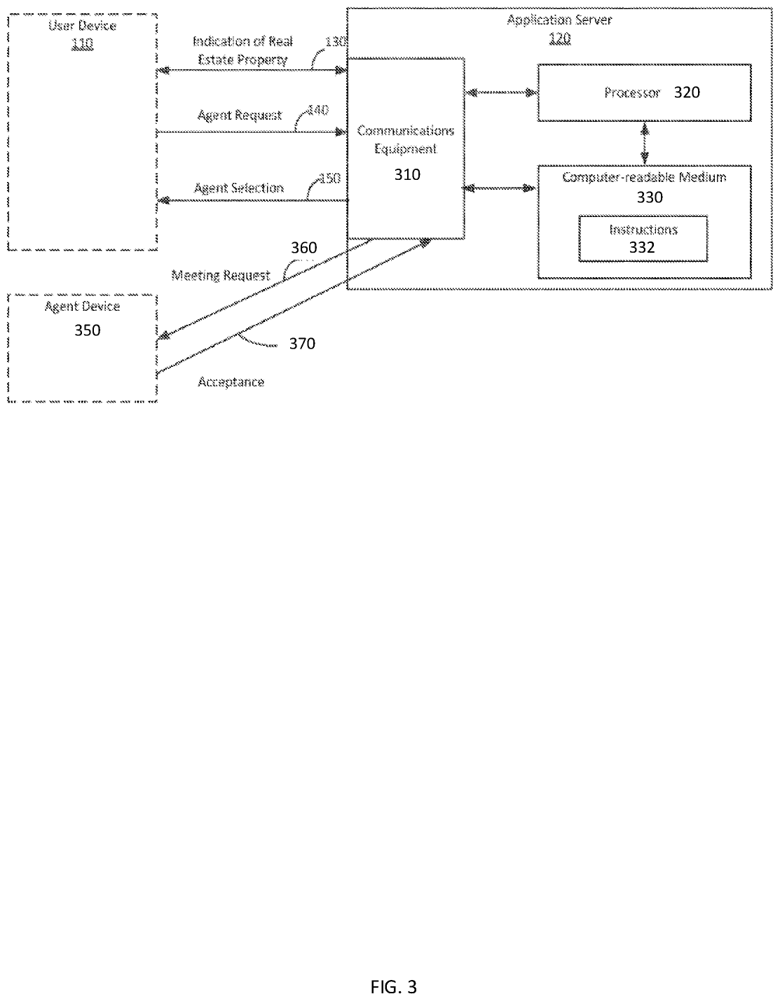

FIG. 3 shows a block diagram of an application server 120 as described herein. The application server 120 comprises communication equipment 210 configured to receive from a user (e.g., a user of a user device 110 or application 112) an indication 130 as described herein of a real estate property. The communication equipment 310 is configured to receive (e.g., from the user device 110 or application 112) an agent request 140 as described herein. For instance, once the user performs a search for a property on user device 110, and selects a property to view, a request to view the property is communicated to the application server 120, via the communications equipment 310. Additionally, a property owner could request an agent to assist with the sale of a real estate property. In both cases, the application server 120 will then search for a listing of possible agents that could represent the property selected on the user device and send the agents a notification 140. Once the agents receive the notification 360, they can accept the request 370 to show the property on a “first come, first serve” basis. Once the agent accepts the showing 370, that notification is sent to the application server 120, then the application server forwards the agent's information to the user/user device 150. At this point, the user can accept the agent or reject the agent. If the agent is accepted, the appointment is scheduled, and they go meet. If the agent is rejected, then the notification rejection is sent back to the application server 120 via the communication equipment 310. The application server 120 will then forward that rejection notification back to the agent 360. Then the notification for an agent request is resent to the agents who can “show” the listing and a new agent can accept 370 on a “first come, first serve” basis.

Communication equipment described herein may be made of one or more interfaces, receivers, or transmitters. For instance, the communications equipment 310 may be an input/output interface or a transceiver. Alternatively, or additionally, the communications equipment comprises separate receivers and transmitters or separate input and output interfaces for sending or receiving information described herein.

The application server 120 also comprises processing equipment. For instance, as shown in FIG. 3, application server 120 comprises a processor 320 and computer-readable medium 330. Computer-readable medium 330 is an electronic holding place or storage for information so the information can be accessed by processor 320. Computer-readable medium 330 can include, but is not limited to, any type of random-access memory (RAM), any type of read-only memory (ROM), any type of flash memory, such as magnetic storage devices (e.g., hard disk, floppy disk, magnetic strips), optical disks (e.g., compact disc (CD)), digital versatile disc (DVD)), smart cards, flash memory devices, and the like.

Processor 320 executes instructions that may be, for example, stored at the computer readable medium 330. The instructions may be carried out by a special purpose computer, logic circuits, or hardware circuits. In one or more embodiments, processor 320 is implemented in hardware and/or firmware. Processor 320 executes an instruction, meaning it performs or controls the operations called for by that instruction. The term “execution” is the process of running an application or the carrying out of the operation called for by an instruction. The instructions can be written using one or more programming language, scripting language, assembly language, and the like. Processor 320 in one or more embodiments can retrieve a set of instructions from a permanent memory device and copy the instructions in an executable form to a temporary memory device that is generally some form of RAM, for example.

In one or more embodiments, computer-readable medium 320 stores instructions for execution by processor 320. For example, computer-readable medium 320 comprises instructions 332 for selecting an agent executable by the processor 320, whereby the application server 120 is configured to perform certain functions for selecting an agent.

For instance, the processing equipment of the application server 120 is configured to determine a current location 160 and/or a location of interest. The location of interest comprises a location of the user or a location of the real estate property for purchase or for sale. For instance, the user may want a real estate agent to meet the user at their current location and go to the real estate property together or meet the agent at the real estate property. Determining a location of interest may include determining a global positioning system (GPS) location of a mobile device or a location for a real estate property located in a database for real estate property listings.

The processing equipment is configured to determine respective current agent locations of available real estate agents. Determining a location of an agent may include determining a GPS location of an agent's mobile device or a location an agent has set with the application server.

The processing equipment is configured to generate respective vehicle routes between the location of interest and each of the respective current agent locations. The processing equipment is configured to compute respective route scores based on the respective vehicle routes. The processing equipment is configured to select, based on the respective route scores, the single selected real estate agent from the plurality of available real estate agents.

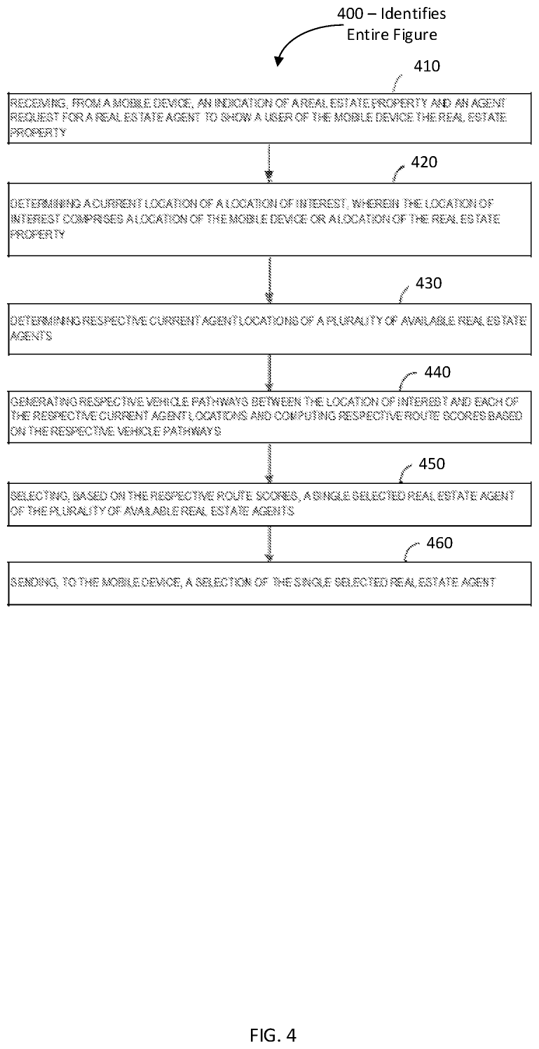

FIG. 4 shows a method 400 for selecting a real estate agent (e.g., implemented by an application server 120).

In one or more embodiments, the method 400 comprises an operation 410 for receiving, from the mobile device, an agent request for a real estate agent to show a user of the mobile device the real estate property or to represent the seller of a real estate property.

In one or more embodiments, the method 400 comprises an operation 430 for determining a current location of a location of interest. The location of interest comprises a location of the mobile device or a location of the real estate property.

In one or more embodiments, the method 400 comprises an operation 440 for generating respective vehicle routes between the location of interest and each of the respective current agent locations and computing respective route scores based on the respective vehicle routes.

In one or more embodiments, the computing of a respective route score is based on factors that may contribute to time to get to a location of interest or a user. For instance, in one or more embodiments, computing a respective route score is based on respective total routes along roads for vehicle access between the location of interest and the respective current agent locations. Alternatively, or additionally, the computing respective route scores is based on physical objects in proximity to a given one of the respective vehicle routes. For example, the physical objects could be traffic lights and other vehicles, which might delay an agent's route to a user or location of interest.

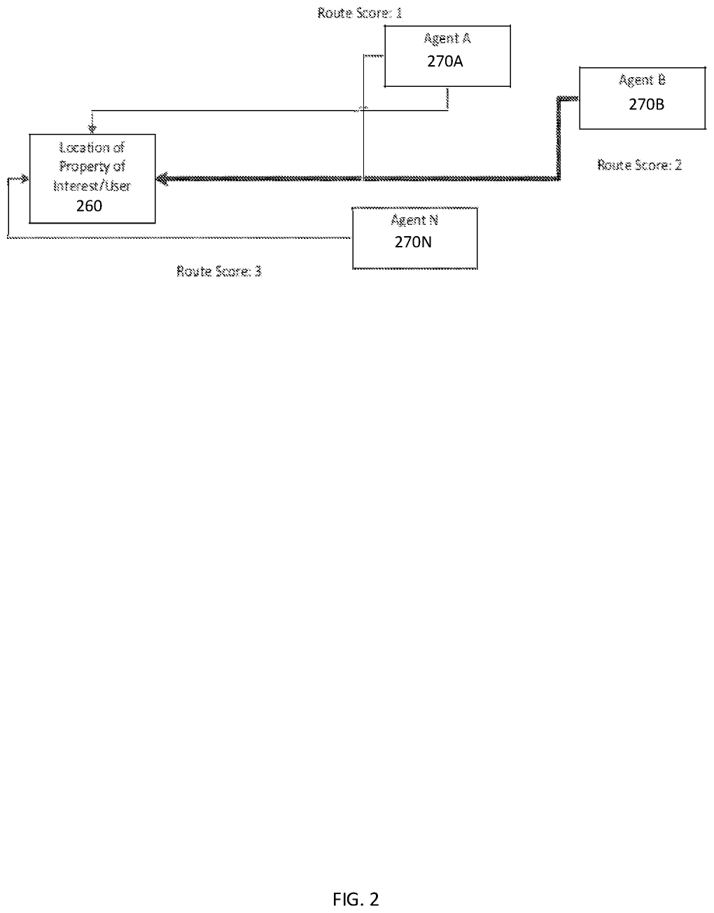

Alternatively, or additionally, the computing respective route scores are based on one or more of the features of a given segment of road along a given one of the respective vehicle routes. For instance, the features could include a quantity of lanes of segments of the vehicle route or locations to change the direction of a vehicle. For instance, as shown in FIG. 2, Agent 270N, must go past the location of interest 260 and turn around to arrive at the location 260 and Agent 270A must take a left turn on one route to get to the location 260. These features may contribute to a longer time to reach location 260. In contrast, Agent 270B has a route, and Agent 270A a partial route, that has more lanes than the other routes. These features may make it quicker for an agent to get to location 260 because the agent is less likely to be slowed by another vehicle.

In one or more embodiments, the method 400 comprises an operation 450 for selecting, based on the respective route scores, a single selected real estate agent from the plurality of available real estate agents (e.g., an agent with the highest route score).

In one or more embodiments (e.g., as part of operation 450), the method 400 comprises determining a given real estate agent of the plurality of available real estate agents has a shortest generated respective vehicle route compared to other generated respective vehicle routes (e.g., based on estimated miles of the route). The method 400 comprises refraining from selecting the given real estate agent based on one or more factors discussed above that might affect the time for an agent to get to a location (e.g., a feature of a given segment of road along the respective vehicle route).

In one or more embodiments, the method 400 comprises an operation 460 for sending to the mobile device a selection of the single selected real estate agent. Individual embodiments described herein (e.g., FIG. 4) may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged (e.g., operation 420 could come before operation 410). Further processes described herein may be used in conjunction or separately from other processes described herein.

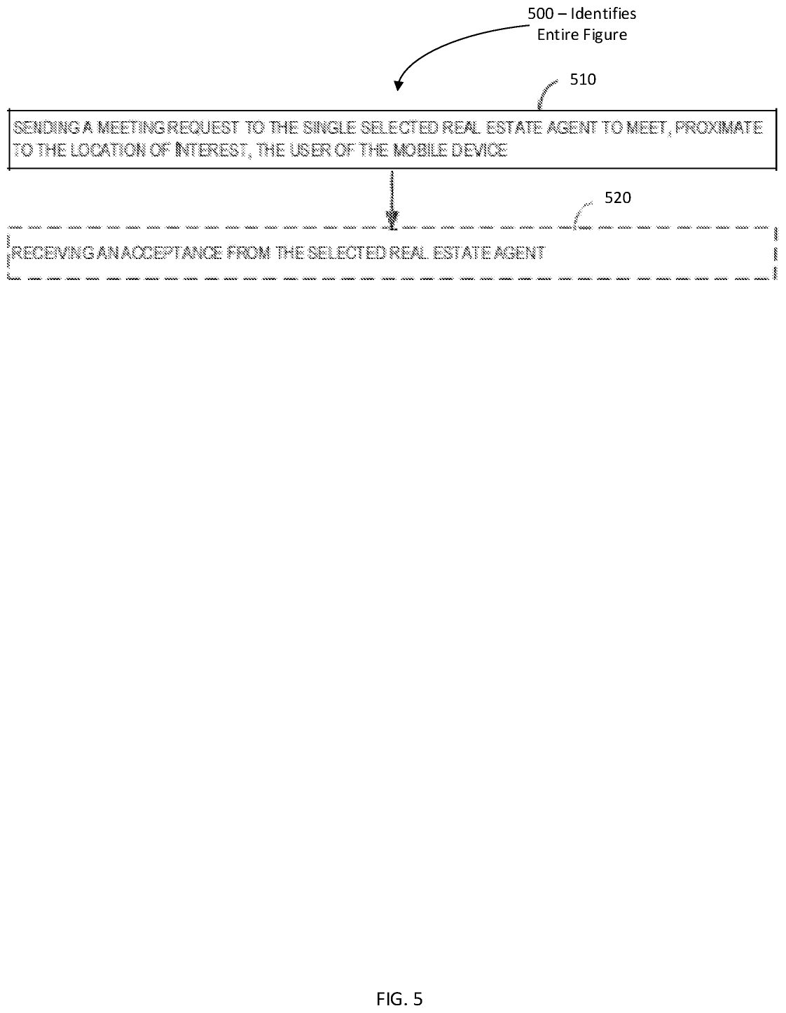

FIG. 5 shows a method 500 for sending a meeting request to a real estate agent (e.g., implemented by an application server 120). In one or more embodiments, the method 500 comprises an operation 510 for sending a meeting request to the single selected real estate agent to meet, proximate to the location of interest, the user of the mobile device. Method 500 can be used separately from method 400 or may alternatively be used in conjunction with method 400. For example, operation 510 can be responsive to operation 450 or 460. FIG. 3 shows an example meeting request 360 going from the application server to an agent device 350.

In one or more embodiments, the method 500 comprises an operation 520 for optionally receiving an acceptance from the selected real estate agent. In some embodiments, acceptance by the agent may be implicit or received before operation 510 (e.g., by indicating from a device of an agent that an agent is generally available to meet buyers). In this way, embodiments herein advantageously are not dependent on real estate agent input to select an agent, which further lessens the burden to the real estate community.

In some embodiments, the acceptance is explicitly given (e.g., responsive to operation 510). In such cases, operation 460 of method 400 may be conditioned on the application server receiving the acceptance (e.g., such that sending a selection of one or more real estate agents to a prospective buyer is responsive to receiving the acceptance from a respective agent). For example, FIG. 3 shows an acceptance 370 going to the application server 120 from an agent device 350.

In one or more embodiments, the agent request 140 may comprise one or more messages that also indicate one or more user preferences for the request (e.g., a mode for selecting or alerting one or more real estate agents, or a message for the real estate agent). For instance, the application server 120 may receive a mode selection of different modes from the user indicating to select and/or alert a single selected real estate agent. Other modes may include a mode for notifying all available agents within a proximity defined by the user. Additionally or alternatively, the application server 120 may receive from the user an indication of a message for a selected real estate agent, the message related to meeting the user of the mobile device (e.g., a delayed time for meeting the user). The application server 120 may generate, responsive to the indication of the message, a generated message for a selected real estate agent, and forward the generated message to an agent device 350 (e.g., in a same or different message as the meeting request 360).

In one or more embodiments, a prospective buyer may not have knowledge of a real estate property. For instance, a user device (e.g., a mobile device) may be used to transmit one or more options for filter settings for filtering available real estate properties. The user device receives an indication of a real estate property that comprises receiving an indication of multiple real estate properties that meet the one or more options for filter settings. The user device transmits a selection of a given one of the multiple real estate properties. Accordingly, an indication of a real estate property described herein (e.g., indication 130) may be a selection of a given one of the multiple real estate properties.

Further, a corresponding or separate method may be implemented by an application server described herein (e.g., application server 120) or a different application server. For instance, an application server may receive, from the mobile device, one or more options for filter settings for filtering available real estate properties, determine multiple real estate properties that meet the one or more options for filter settings, and send an indication of the multiple real estate properties.

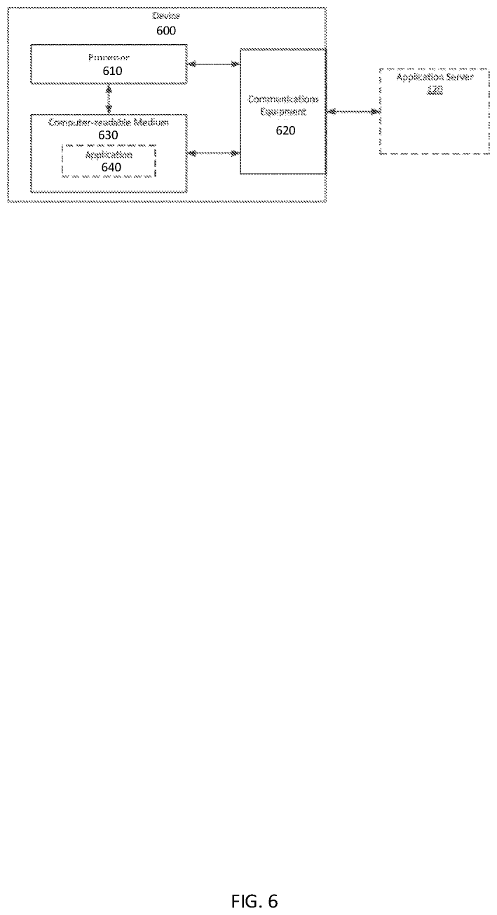

FIG. 6 shows a block diagram for a device (e.g., user device 110 or agent device 250) according to one or more embodiments herein. The device 600 comprises communications equipment 620 for communicating with one or more entities described herein (e.g., an application server 120). For example, the communications equipment 620 may be configured for sending or transmitting an indication 130 of a real estate property, an agent request 140, and/or an acceptance 370. Additionally, or alternatively, the communications equipment 620 is configured for receiving an agent selection 150 and/or a meeting request 260. In one or more embodiments, the communications equipment 620 comprises features of interfaces or transmitter/receiver devices described herein with respect to FIG. 3.

In one or more embodiments, the device 600 is a user device and comprises processing equipment configured to receive an indication of a real estate property; transmit an agent request requesting a real estate agent to show a user of the mobile device the real estate property; and receive a selection of a single selected real estate agent of a plurality of available real estate agents. The selection can be based on a computation of a route score for a vehicle route from the selected real estate agent to a location of the real estate property or the user of the mobile device as described herein.

In one or more embodiments, the device 600 is an agent device with processing equipment configured for transmitting a meeting request 360 or receiving an acceptance 370 described herein.

For instance, the device 600 comprises a processor 610 and a computer-readable medium 630 with one or more features of processors and computer-readable medium described herein. For instance, the computer-readable medium 630 may comprise instructions for an application or client described herein (e.g., application 112).

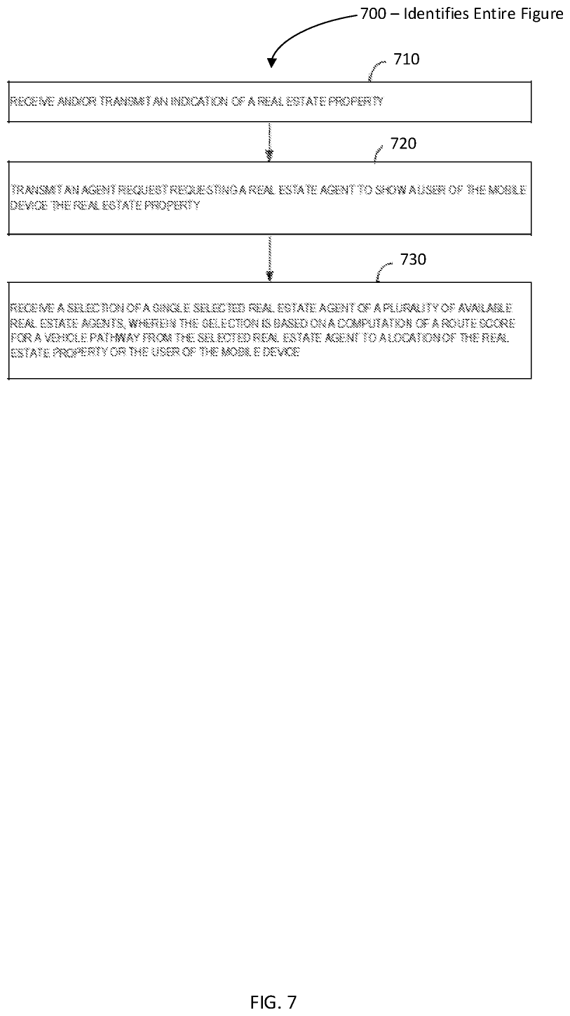

FIG. 7 is an example method 700 for receiving a selection of a real estate agent (e.g., implemented by a user device described herein).

In one or more embodiments, the method 700 comprises an operation 710 for receiving and/or transmitting an indication of a real estate property. For instance, in one or more embodiments, the operation 710 may include transmitting one or more options for filter settings for filtering available real estate properties and receiving an indication of multiple real estate properties that meet the one or more options for filter settings. The operation 710 could include transmitting a selection of a given one of the multiple real estate properties.

In one or more embodiments, the method 700 comprises an operation 720 for transmitting an agent request as described herein requesting a real estate agent to show a user of the mobile device the real estate property. For instance, the agent request could include preferences of a user of the device (e.g., a mode for agent selection or a message to an agent).

In one or more embodiments, the method 700 comprises an operation 730 for receiving a selection of a single selected real estate agent from a plurality of available real estate agents. The selection may be based on a computation of a route score for a vehicle route from the selected real estate agent to a location of the real estate property or the user of the mobile device as described herein. The operation 730 could comprise transmitting a rejection of the selection of the single selected real estate agent (e.g., based on a real-time update of the agent's location) and receiving an updated selection of another real estate agent from the plurality of available real estate agents based on computed respective route scores for each of available real estate agents.

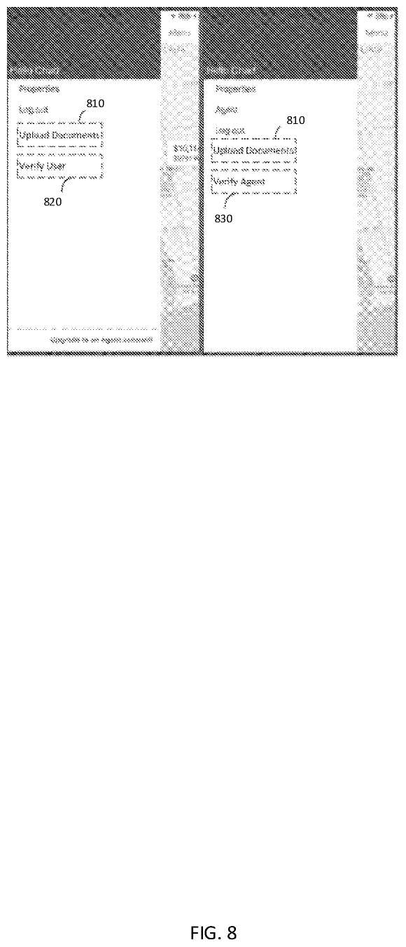

FIG. 8 shows a graphical user interface of a device for registering with the application server (e.g., an application server described herein). The screen on the left shows an example registration for a prospective buyer on a user device described herein. The screen on the right shows an example registration for a real estate agent on an agent device described herein.

Optionally, either account may have optional additional features relevant to the real estate agent-user relationship. For example, accounts may be able to upload and store documents relevant to the representation. Documents could include, for example, a pre-qualification letter for a loan, allergy information of a prospective buyer/agent (e.g., dog and cat allergies), or even an offer on a home. A user device could be configured to store the information on the user device and/or remotely at the application server (e.g., in response to a request from the application server for this information).

Optional additional features could include a verify user features 820 for verifying information about a user to a prospective agent (e.g., whether the user is a real person, has met loan qualifications to look at homes, and does not have a criminal record). For instance, an application server could generate a verified identify associated with a user device by verifying an identify of a user of the user device; associating the identify with an identifier of the user device (e.g., an international mobile equipment identity, IMEI); and sending the selection of the single selected real estate agent only to the verified identity associated with the mobile device.

Optional additional features may include a verify agent feature 830 for verifying information about an agent to a prospective buyer (e.g., whether the agent is licensed, whether the agent has a criminal record, and/or whether the agent has traffic violations). Determining whether the agent is licensed may involve determining whether the agent has a valid and not revoked multiple listing service (MLS) number.

Verified information about a buyer or agent may be confirmed at registration for an account. A successful registration may involve providing information about a device, such as a device identification, for associating with an account successfully registered or a multi-factor identification for logging back into a registered account. Additionally, or alternatively, this information may be confirmed periodically or optionally. For example, an agent may want to show a prospective buyer that the agent has recently verified his/her status as an agent. Verification may involve an application server contacting other application servers for information relevant to the account.

Accordingly, one or more embodiments advantageously provide security or credibility for an in-person meeting between a buyer and agent acquainted over an electronic system.

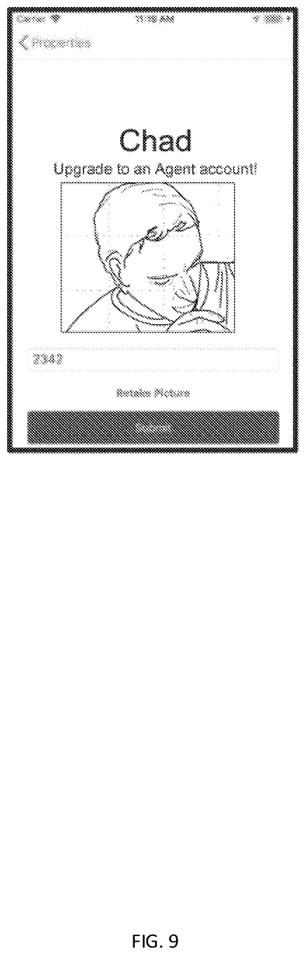

FIG. 9 shows a graphical user interface of a device for upgrading to an agent account. Upgrading to an agent account may require additional conditions (e.g., payment of a fee or additional verifications). For example, an application server may receive many registrations from candidate real estate agents at different real estate companies and only consider agents available if the candidate real estate agent is a licensed real estate agent and registered as a verified candidate real estate agents. An upgraded agent account may enable additional features such as the ability to update a photo associated with the account or to let an application server know that an agent is available to show a prospective buyer a home.

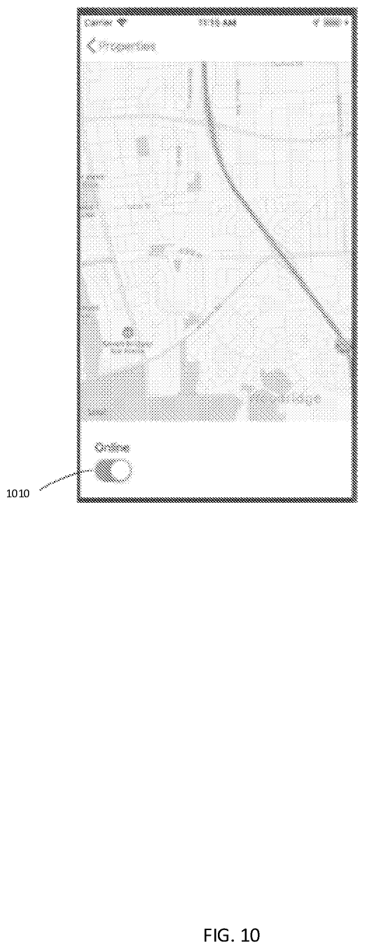

FIG. 10 shows a graphical user interface of a device for indicating that a user is currently available (e.g., for showing buyers a property). This status information may be provided by toggling an indicator 1010 in the graphical user interface. This status information could occur in response to other agent action such as logging into an account through an agent device. In one or more embodiments, the application server receives a status indication from registered real estate agents and classifies registered real estate agents as available real estate agents for determining the respective current agent locations responsive to a status indication.

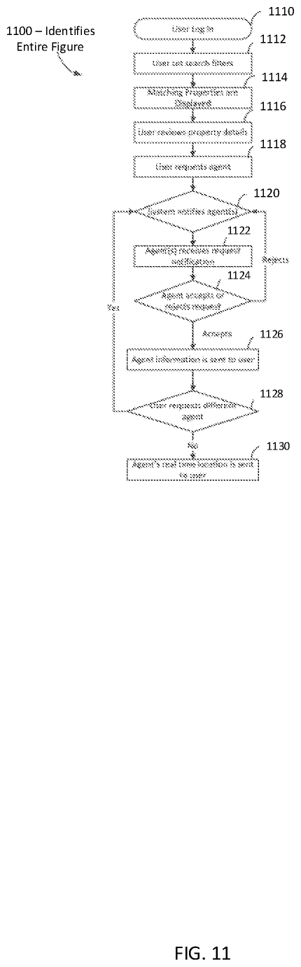

FIG. 11 shows an example process 1100 for selecting an agent. In an operation 1110, a user logs into an application on the user's mobile device. The user sets search filters in an operation 1112 and in response (e.g., from application server), the user receives a display (e.g., on a graphical user interface of the mobile device) of matching properties in an operation 1114. In an operation 1116, the user reviews property details. In an operation 1118, the user requests an agent to look at one of the reviewed properties or another property.

FIG. 11 shows an operation 1120 for notifying one or more agents and an operation 1122 in which the agent receives an agent request notification. This may be a notification of a user that is requesting an agent or a general request for agents to indicate their availability to show a prospective buyer a home.

In an operation 1124, the agent accepts or rejects the request. If a rejection is made, the system may need to notify other agents to determine availability of other agents that the user may be able to select. In an operation 1126, if one or more agents accept the request, agent information for a selected agent can be sent to the user. For instance, the agent information could include, for example, one or more of a photo of the agent, a name of the agent, a phone number or email address of the agent, a real-time location of the agent, and a biography of the agent.

FIG. 11 shows an example operation 1128 in which the user requests a different agent. For example, a user may not personally like the agent and feel uncomfortable meeting with that agent. Additionally, or alternatively, the rejection of the selection of a real estate agent may be responsive to sending an indication of real-time location of the real estate agent traveling to the location of interest. The user may feel that the agent is too far or is not moving quickly enough and decide to work with a different agent.

In one or more embodiments, described herein an application server may receive from a user a rejection of a selected real estate agent, and send an updated selection of another real estate agent of available real estate agents based on the computed respective route scores. As shown in FIG. 11, this may require implementing other operations again (e.g., notifying an agent in an operation 1120).

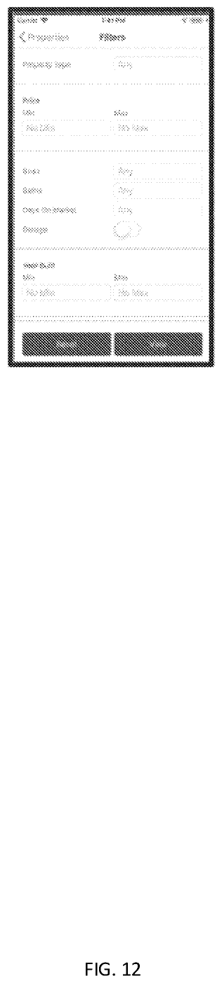

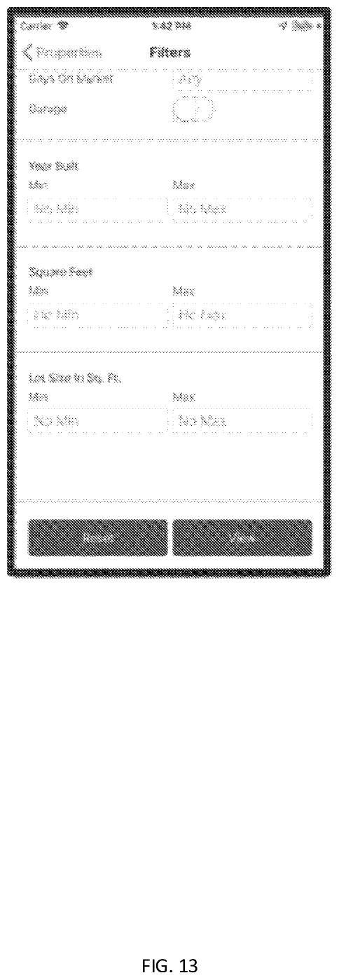

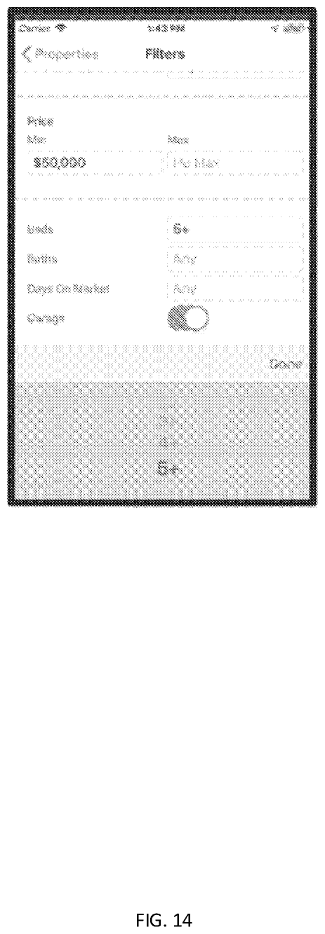

FIGS. 12-14 show a graphical user interface for presenting various filter settings to a user of a device. The filter settings are used for receiving an indication of one or more real estate properties for user selection of a real estate property that may be displayed in one or more windows of a user's device.

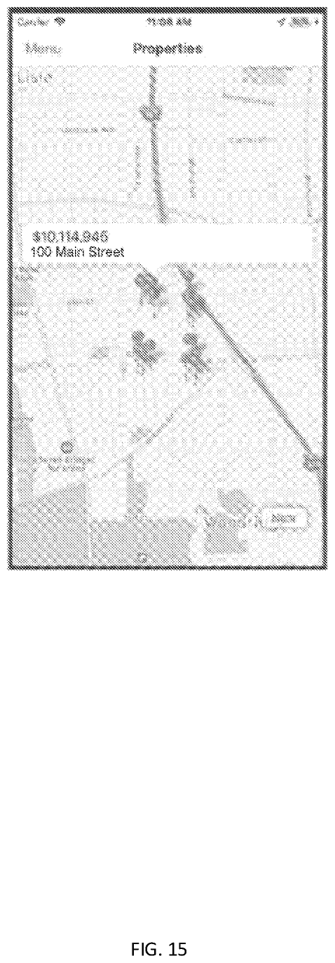

FIG. 15 shows a graphical user interface on a user device of matching real estate properties for selection by the user.

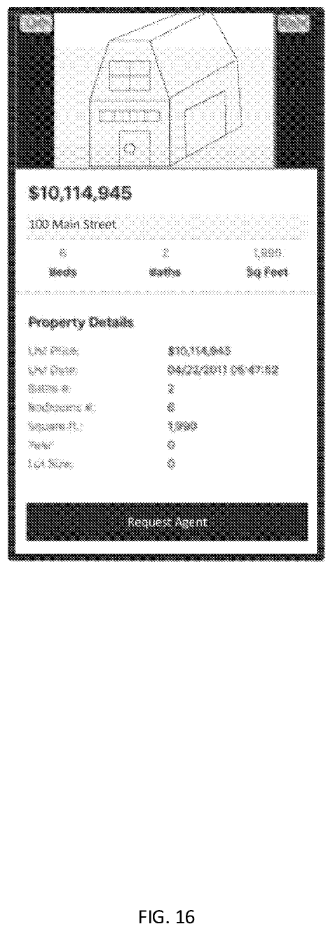

FIG. 16 shows a graphical user interface on a user device of property details of a selected matching real estate property.

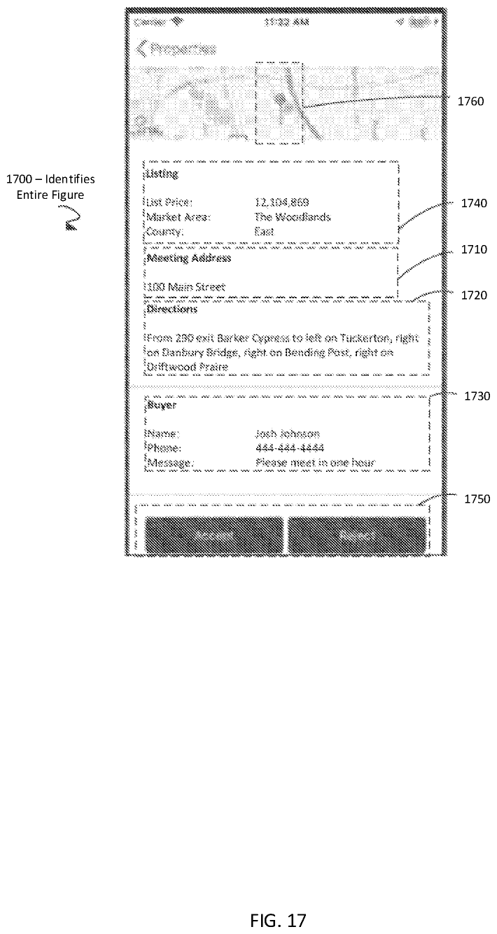

FIG. 17 shows an agent device with a graphical user interface 1700 showing information in response to an agent request as described herein. The information may optionally include meeting information 1710 indicating a meeting location, route information 1720, buyer information 1730, property information 1740, and location information 1760. The meeting information may be the same as the address of the property, a current address of the user, or another location selected by the user. The buyer information may optionally include a message for the real estate agent for facilitating the meeting (e.g., a delayed start time, an identifier of the buyer or buyer's vehicle, etc.). The graphical user interface 1700 optionally includes location information 1760 that may, for example, indicate a location of the listing in a map or a real-time location of a buyer.

The graphical user interface 1700 optionally includes controls 1750 for manipulation by the agent (e.g., to accept or reject a request to show a buyer a home).

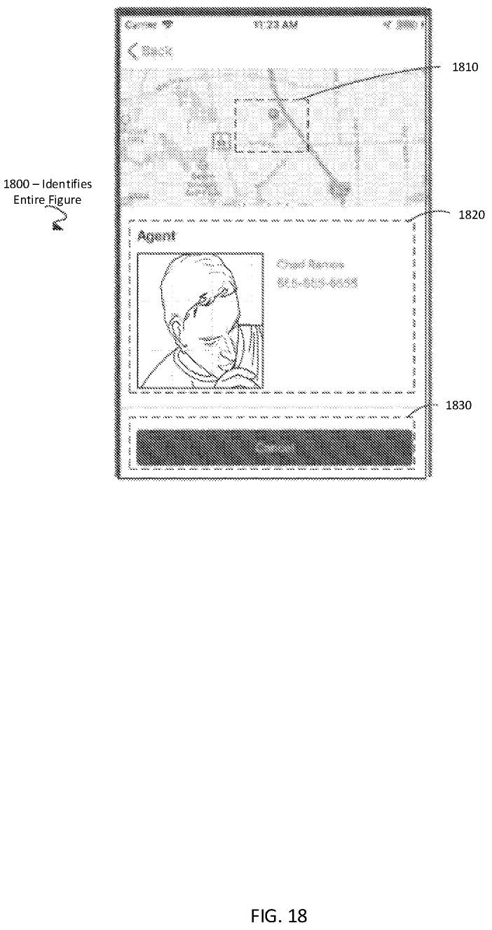

FIG. 18 shows a graphical user interface 1800 for alerting or notifying a buyer of a selected agent. The alert may optionally include agent information 1820 identifying the agent (e.g., a picture, name, phone number and a biography). The alert may optionally include a real-time location 1810 of the agents. The example shown in FIG. 18 represents the real-time location 1810 in a map form. Alternatively, or additionally, the real-time location 1810 could be representing in other ways (e.g., a text report of estimated distance away from the meeting location or current street). The alert may optionally include controls 1830 for rejecting the agent or for messaging the agent (e.g., to let them know of buyer delay).

One or more embodiments herein may empower the potential buyer by allowing the buyer to search in real time for properties based upon any number of filters and their current physical location. Properties meeting the selected criteria and/or within a defined proximity to the user's current location will be displayed in real time on the user's mobile device for a detailed review. Once a property of interested is identified, the user can simply request a sales agent. One or more embodiments utilize the current location of the potential buyer, the property of interest and/or the real time location of available sales agents to select the appropriate agent. The agent will be notified on her mobile device to allow her to accept or reject the request to view the property. If an agent elects to accept the request the agent's information and current location can be displayed on the buyer's device. The agent's location information will be updated in real time allowing for the buyer to determine approximate arrival time. The buyer has the ability at any time to cancel the request and (if needed) request a different agent. If the recommended agent elects to reject the request, one or more systems described herein will identify and notify the next available agent. One or more systems described herein can also support the ability to notify all available agents within a defined proximity to the buyer. In this mode the first agent to accept the request will be defined as the “claimed agent.”

1. A software application comprising;
a. a means to executes instructions sent from the graphical user interface (GUI) on a user device to an application server for the purpose of assisting users with identifying and locating a real estate property and an agent that can represent said real estate property for purchase or for sale;
b. an application server that executes computations that will allow for the calculation of the route between a real estate property and a real estate agent wherein the application will send the results of the computation to said user's device whereupon it will display said results on the GUI;
wherein the Graphical User Interface (GUI) will reside and be accessed from the user device;
wherein said GUI will communicate the request for a real estate agent to the application server;
wherein the software application that performs the computation of the routes between the real estate property and the selected real estate agent will reside on the application server;
wherein said GUI on the user device will communicate with said application server for the purpose of identifying, locating, and selecting a real estate property that the user would like to purchase;
wherein said GUI on the user device will communicate with said application server for the purpose of identifying real estate agent to represent a property seller;
wherein said application server will respond to the request for a real estate agent with a plurality of real estate agents that can represent the selected property;
wherein said software application on the application server will provide a recommended agent to the user device;
wherein the selection of the recommended agent was provided by the application server based on a “first come, first serve” response from a real estate agent; and
wherein the application server will send a notification to the selected real estate agents, whereupon the agents who receive the notification will have the option to accept or reject an appointment for viewing the property, or representing the seller, with said user from real estate agent's GUI on said real estate agent's user device.

2. A software application as recited in claim 1, wherein GUI that resides on said user device provides the means for users to create individual profiles to be used for accessing or logging into said software application for the purpose locating real estate agents who can show said users a selected property or represent a property that the users would like to sale.

3. A software application as recited in claim 1, wherein user of the mobile device would have the ability to input various criterion or filters into said GUI of the user device, wherein the criteria or filters are based on general location of desired property, number of bedrooms, number of bathrooms, days on the market, year built, and purchase price range.

4. A software application as recited in claim 1, wherein user of the mobile device would have the ability to input various detail regarding a property for the purpose of locating a real estate agent to represent the sale of said property.

5. A software application as recited in claim 1, wherein the user device will receive notifications of real estate properties that match said provided criteria or filters as provided by said user.

6. A mobile software application as recited in claim 1, wherein the user will select the property of interest on the GUI of their user device thereby sending a request to the application server to perform computation to determine the location of interest such that the location of interest is the location of the real estate agent's mobile device in reference to the location of the real estate property or another specified location.

7. A mobile software application as recited in claim 1, wherein the user's device will receive notifications from the application server for real estate agent that responded to the agent request first.

8. A software application as recited in claim 1, wherein the GUI further comprises receiving a mode selection of a plurality of modes from the user of the user device;
a. wherein the plurality of modes comprises a first mode for receiving only a single real estate agent;
b. wherein and the plurality of modes comprises a second mode for notifying all available agents within a proximity defined by the user; and
c. wherein the selecting of the single selected real estate agent is responsive to receiving a mode selection of the first mode.

9. A software application as recited in claim 1, wherein the software application comprises: receiving a plurality of registrations from candidate real estate agents at different real estate companies; and determining available real estate agents by verifying that each of the candidate real estate agents is a licensed real estate agent; and registering verified candidate real estate agents as registered real estate agents.

10. A software application as recited in claim 1, wherein the software application comprises:
a. generating a verified identity associated with the mobile device by verifying an identity of a user of the mobile device;
b. associating the identity with an identifier of the mobile device (e.g., an international mobile equipment identity, IMEI); and
c. sending the selection of the single selected real estate agent only to the verified identity associated with the mobile device.

11. An application server that computes route scores comprising:
a. communication equipment configured to:
i. receive, from a user device, an indication of a real estate property; receive, from the user device, a request for a real estate agent to show a user of the mobile device the real estate property; and send, to the mobile device, a selection of a single selected real estate agent; and
b. processing equipment configured to:
i. determine a current location of a location of interest, wherein the location of interest comprises a location of the mobile device or a location of the real estate property;
ii. determine respective current agent locations of a plurality of available real estate agents;
iii. generate respective vehicle routes between the location of interest and each of the respective current agent locations;
iv. compute respective route scores based on the respective vehicle routes; and
v. select, based on the respective route scores, the single selected real estate agent of the plurality of available real estate agents.

12. An application server, wherein said application server comprises: a non-transitory computer-readable storage medium containing a computer program comprising executable instructions that, when executed by a processing circuit of a mobile device, causes a mobile device to perform any of the methods of embodiments 1-10.

13. An application server as recited in claim 11, wherein the application server comprises:
a. receiving an indication of a message for the single selected real estate agent, the message related to meeting the user of the mobile device;
b. generating, responsive to the indication of the message, a generated message for the single selected real estate agent; and
c. forwarding the generated message to the single selected real estate agent.

14. An application server as recited in claim 11, wherein the application server comprises: a software application used to identify respective vehicle routes which will be used for the purpose of computing respective route scores for each of the presented real agents.

15. An application server as recited in claim 11, wherein computing of the respective route scores includes an accounting for physical objects, such as traffic lights, detour, accidents, traffic volume, and/or anything that may cause a time delay for the agent to reach the property, in proximity to respective vehicle routes.

16. An application server as recited in claim 11, wherein computing a route score also accounts for one or more features of the given segment of road including a quantity of lanes of segments of the vehicle route or locations to change the direction of a vehicle.

17. An application server as recited in claim 11, wherein the notification from the application server regarding the real estate agent based on a “first come, first serve” response to the request to view the property.

18. An application server as recited in claim 11, wherein the application server comprises; receiving a status indication from registered real estate agents; and classifying registered real estate agents as available real estate agents for determining the respective current agent locations responsive to the status indication.

19. An application server as recited in claim 11, wherein the application server comprises; the user accepting the real estate agent that responded first to the agent request, thus sending the selection notification to the mobile device of the selected real estate agent.

20. An application server as recited in claim 11, wherein a response to selecting an agent, sends a meeting request to the single selected real estate agent to meet the user at the location of the property upon receiving an acceptance from the selected real estate agent.

21. An application server as recited in claim 11, wherein the sending of the selection of the single selected real estate agent is responsive to receiving the acceptance or rejection.

22. An application server as recited in claim 11, wherein if the user device receives an acceptance the real estate and the user can agree on a time to meet.

23. An application server as recited in claim 11, wherein if the user device receives a rejection from the single selected real estate agent, the application server will send a new real estate agent that responds first to the new notification for an agent request.

24. An application server as recited in claim 11, wherein the receiving of the rejection of the selection of the single selected real estate agent is responsive to sending an indication of real-time location of the single selected real estate agent traveling to the location of interest.

25. An application server as recited in claim 11, wherein said application server comprises: a non-transitory computer-readable storage medium containing a computer program comprising executable instructions that, when executed by a processing circuit of an application server, causes the application server to perform any of the methods of embodiments 11-21.

26. A mobile device comprising communication equipment configured to:
a. receive an indication of a real estate property;
b. transmit an agent request requesting a real estate agent to show a user of the mobile device the real estate property; and
c. receive a selection of a single selected real estate agent, wherein the selection is based on a computation of a route score for a vehicle route from the selected real estate agent to a location of the real estate property or the user of the mobile device; and processing equipment configured to determine when to transmit the agent request.
